(19) United States
(12) Patent Application Publication
(10) Pub. No.: US 2026/0019856 A1
(43) Pub. Date: Jan. 15, 2026

(54) RESOURCE AND RATE MATCHING PATTERNS FOR CROSS LINK INTERFERENCE MEASUREMENTS IN SUBBAND FULL DUPLEX

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US); Qian ZHANG, Basking Ridge, NJ (US)

(21) Appl. No.: 19/203,097

(22) Filed: May 8, 2025

Related U.S. Application Data
(60) Provisional application No. 63/669,974, filed on Jul. 11, 2024.

(51) Int. Cl. H04W 24/10

(52) U.S. Cl. CPC H04W 24/10

(57) ABSTRACT

Methods, systems, and devices for wireless communication are described. The method may include receiving a signal configuring the user equipment (UE) with one or more resource mappings associated with cross link interference (CLI) measurements and one or more rate matching patterns associated with receiving a data signal multiplexed with the cross link interference measurements. The method may further include measuring CLI in first resources of a downlink data channel in accordance with a rate matching pattern and receiving the data signal via second resources of the downlink data channel in accordance with the rate matching pattern. The method may further include transmitting a report indicating the measured CLI.

### CROSS REFERENCES

The present Application for Patent claims benefit of U.S. Provisional Patent Application No. 63/669,974 by IBRAHIM et al., entitled “RESOURCE AND RATE MATCHING PATTERNS FOR CROSS LINK INTERFERENCE MEASUREMENTS IN SUBBAND FULL DUPLEX,” filed Jul. 11, 2024, assigned to the assignee hereof, and expressly incorporated herein.

### FIELD OF TECHNOLOGY

The following relates to wireless communication, including resource and rate matching patterns for cross link interference (CLI) measurements in subband full duplex (SBFD).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, devices of a wireless communications system may support subband full duplex (SBFD). While communicating with one another in accordance with SBFD, one or more of the devices of the wireless communications system may encounter cross link interference (CLI).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a signal configuring the UE with one or more resource mappings associated with cross link interference (CLI) measurements and one or more rate matching patterns associated with receiving a data signal multiplexed with the CLI measurements, measuring CLI in a first set of resources of a downlink data channel in accordance with a rate matching pattern of the one or more rate matching patterns, receiving the data signal via a second set of resources of the downlink data channel in accordance with the rate matching pattern, and transmitting a report indicating the measured CLI.

A UE for wireless communications is described. The UE may include one or more memories storing processor executable code, and one or more processors coupled with the one or more memories. The one or more processors may individually or collectively be operable to execute the code to cause the UE to receive a signal configuring the UE with one or more resource mappings associated with CLI measurements and one or more rate matching patterns associated with receiving a data signal multiplexed with the CLI measurements, measure CLI in a first set of resources of a downlink data channel in accordance with a rate matching pattern of the one or more rate matching patterns, receive the data signal via a second set of resources of the downlink data channel in accordance with the rate matching pattern, and transmit a report indicating the measured CLI.

Another UE for wireless communications is described. The UE may include means for receiving a signal configuring the UE with one or more resource mappings associated with CLI measurements and one or more rate matching patterns associated with receiving a data signal multiplexed with the CLI measurements, means for measuring CLI in a first set of resources of a downlink data channel in accordance with a rate matching pattern of the one or more rate matching patterns, means for receiving the data signal via a second set of resources of the downlink data channel in accordance with the rate matching pattern, and means for transmitting a report indicating the measured CLI.

A non-transitory computer-readable medium storing code for wireless communications is described. The code may include instructions executable by one or more processors to receive a signal configuring the UE with one or more resource mappings associated with CLI measurements and one or more rate matching patterns associated with receiving a data signal multiplexed with the CLI measurements, measure CLI in a first set of resources of a downlink data channel in accordance with a rate matching pattern of the one or more rate matching patterns, receive the data signal via a second set of resources of the downlink data channel in accordance with the rate matching pattern, and transmit a report indicating the measured CLI.

Some examples of the method, UEs, and non-transitory computer-readable medium described herein may further include operations, features, means, or instructions for transmitting a signal indicating a capability of the UE to support the one or more resource mappings, the one or more rate matching patterns, or both, where receiving the signal configuring the UE with the one or more resource mappings and the one or more rate matching patterns may be based on the signal indicating the capability to support the one or more resource mappings, the one or more rate matching patterns, or both.

Some examples of the method, UEs, and non-transitory computer-readable medium described herein may further include operations, features, means, or instructions for receiving a signal configuring the UE with one or more second resource mappings associated with channel state information (CSI) measurements, where the one or more resource mappings include a resource mapping of the one or more second resource mappings.

Some examples of the method, UEs, and non-transitory computer-readable medium described herein may further include operations, features, means, or instructions for receiving a signal configuring the UE with one or more third resource mappings associated with CSI interference measurements (CSI-IM), where the one or more resource mappings include a resource mapping of the one or more third resource mappings.

In some examples of the method, UEs, and non-transitory computer-readable medium described herein, a resource mapping of the one or more resource mappings indicates to utilize all resource elements (REs) of a resource block (RB) to perform CLI measurements.

In some examples of the method, UEs, and non-transitory computer-readable medium described herein, the one or more resource mappings include a comb pattern.

In some examples of the method, UEs, and non-transitory computer-readable medium described herein, the signal configuring the UE with the one or more resource mappings and the one or more rate matching patterns indicates to perform CLI measurements in every RB of a bandwidth (BW) associated with the UE.

In some examples of the method, UEs, and non-transitory computer-readable medium described herein, the signal configuring the UE with the one or more resource mappings and the one or more rate matching patterns indicates to perform CLI measurements in a subset of RBs of a BW associated with the UE.

In some examples of the method, UEs, and non-transitory computer-readable medium described herein, the signal configuring the UE with the one or more resource mappings and the one or more rate matching patterns includes an information element (IE) associated with CLI measurements and the IE comprises the one or more resource mappings, and the one or more rate matching patterns are based at least in part on the one or more resource mappings.

In some examples of the method, UEs, and non-transitory computer-readable medium described herein, the signal configuring the UE with the one or more resource mappings and the one or more rate matching patterns includes an IE associated with zero power CSI reference signals (ZP-CSI-RSs) and the IE includes the one or more rate matching patterns.

In some examples of the method, UEs, and non-transitory computer-readable medium described herein, the report includes received signal strength indicator (RSSI) measurements.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports resource and rate matching patterns for cross link interference (CLI) measurements in subband full duplex (SBFD) in accordance with one or more aspects of the present disclosure.

FIG. 2 shows an example of a wireless communications system that supports resource and rate matching patterns for CLI measurements in SBFD in accordance with one or more aspects of the present disclosure.

FIG. 3 shows an example of a resource pattern that supports resource and rate matching patterns for CLI measurements in SBFD in accordance with one or more aspects of the present disclosure.

FIG. 4 shows an example of a process flow that supports resource and rate matching patterns for CLI measurements in SBFD in accordance with one or more aspects of the present disclosure.

FIGS. 5 and 6 show block diagrams of devices that support resource and rate matching patterns for CLI measurements in SBFD in accordance with one or more aspects of the present disclosure.

FIG. 7 shows a block diagram of a communications manager that supports resource and rate matching patterns for CLI measurements in SBFD in accordance with one or more aspects of the present disclosure.

FIG. 8 shows a diagram of a system including a device that supports resource and rate matching patterns for CLI measurements in SBFD in accordance with one or more aspects of the present disclosure.

FIGS. 9 and 10 show flowcharts illustrating methods that support resource and rate matching patterns for CLI measurements in SBFD in accordance with one or more aspects of the present disclosure.

### DETAILED DESCRIPTION

A wireless communications system may support sub-band full duplex (SBFD) communication which may allow devices of the wireless communications system to transmit and receive using the same time resources, but different frequency resources. While performing SBFD communications, devices of the wireless communications system may encounter cross link interference (CLI). In order to account for CLI, one or more of the devices may perform CLI measurements using a pre-configured resource pattern and report the measured CLI to a network entity.

As described herein, a UE may receive a control signal configuring the UE with multiple candidate resource patterns for CLI measurement. The multiple candidate resource patterns may be based on resource patterns allocated for channel state information interference measurement (CSI-IM), resource patterns allocated for CSI measurements, a comb pattern, etc. Additionally, the configuration signal may configure the UE with multiple rate matching patterns. The multiple rate matching patterns may include one or more of the candidate resource patterns or different resource patterns. The rate matching pattern may allow the UE to simultaneously receive a data signal and measure CLI in a downlink data channel. Upon receiving the configuration signal, the UE may measure CLI (e.g., in accordance with a configured resource pattern or a configured rate matching pattern) and report the measured CLI to a network entity. The methods as described here may provide a framework to support multiple candidate resource patterns for CLI measurement.

Aspects of the disclosure are initially described in the context of wireless communications systems. Additional aspects are described in the context of a process flow and a resource pattern. Aspects of the disclosure are further illustrated by and described with reference to apparatus diagrams, system diagrams, and flowcharts that relate to resource and rate matching patterns for CLI measurements in SBFD.

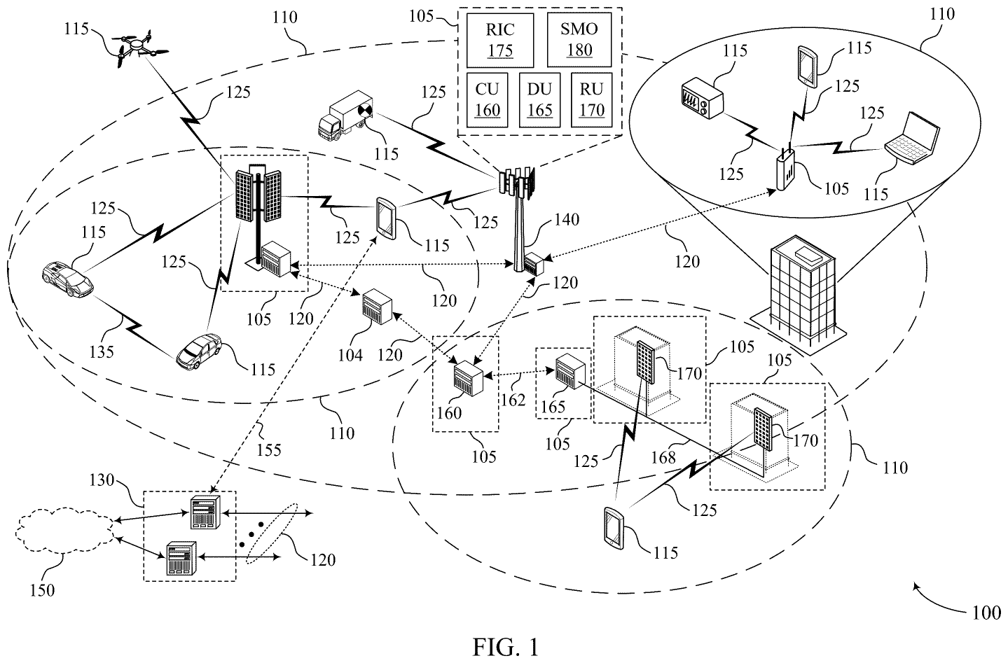

FIG. 1 shows an example of a wireless communications system 100 that supports resource and rate matching patterns for CLI measurements in SBFD in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IA B node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)) . In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular BW of the RF spectrum and, in some examples, the carrier BW may be referred to as a “system BW” of the carrier or the wireless communications system 100. For example, the carrier BW may be one of a set of BWs for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier BW or may be configurable to support communications using one of a set of carrier BWs. In some examples, the wireless communications system 100 may include network entities 105 or UEs 115 that support concurrent communications using carriers associated with multiple carrier BWs. In some examples, each served UE 115 may be configured for operating using portions (e.g., a sub-band, a BWP) or all of a carrier BW.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, an RE may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system BW or a subset of the system BW of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. A n aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, devices of the wireless communications system 100 (e.g., the UE 115 and the network entity 105) may perform rate matching in order to transmit or receive encoded bits. Rate matching may be described as mapping encoded bits to available resources. In some examples, a quantity of encoded bits may be greater than or less than the available resources. In such case, the device may rate match the encoded bits by discarding or adding bits in order to fit the available resources. In order to perform the rate matching for a particular type of signaling, the device may have knowledge of which resources are available for that particular type of signaling. For example, the device may intend to receive or transmit a first type of signaling using a downlink data channel. If the downlink data channel is reserved for a second type of signaling, the device may have knowledge of a rate matching pattern associated with the second type of signaling (e.g., resources allocated for the second type of signaling) such that the device may rate match the first type of signaling around the second type of signaling (e.g., resources not allocated for the second type of signaling).

As described herein, a device (e.g., the UE 115 and the network entity 105) may support multiple candidate resource mappings and multiple rate matching patterns for CLI measurement. In some examples, the UE 115 may receive, from the network entity 105, a signal configuring the UE 115 with one or more resource mappings associated with CLI measurements and one or more rate matching patterns associated with receiving a data signal multiplexed with the CLI measurements. Further, the UE 115 may measure CLI in a first set of resources of a downlink data channel in accordance with a rate matching pattern of the one or more rate matching patterns. Additionally, the UE 115 may receive, from the network entity 105 and via a second set of resources of a downlink data channel, the data signal in accordance with the rate matching pattern. Upon measuring the CLI, the UE 115 may transmit, to the network entity 105, a CLI report indicating the measured CLI.

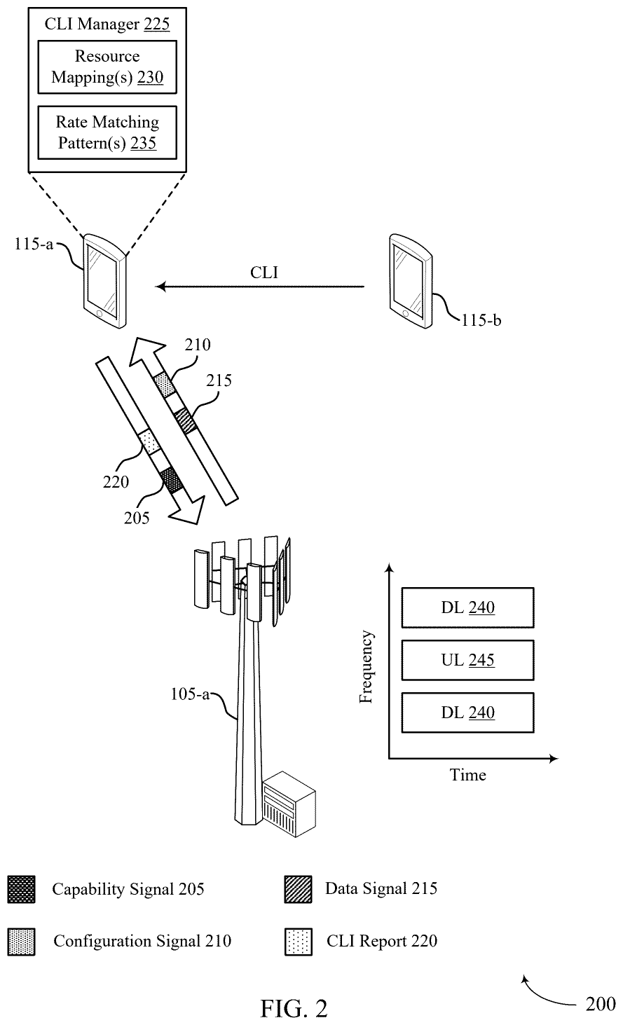

FIG. 2 shows an example of a wireless communications system 200 that supports resource and rate matching patterns for CLI measurements in SBFD in accordance with one or more aspects of the present disclosure. In some examples, the wireless communications system 200 may implement aspects of the wireless communications system 100. For example, the wireless communications system 200 may include UEs 115 (e.g., a UE 115-a and a UE 115-b) which may be examples of UEs 115 as described with reference to FIG. 1. Further, the wireless communications system 200 may include a network entity 105-a which may be an example of a network entity 105 as described with reference to FIG. 1.

In some examples, one or more devices of the wireless communications system 200 may support SBFD. A device that supports SBFD may be capable of transmitting signaling and receiving signaling over the same time resources, but different frequency resources. For example, the network entity 105-a may transmit signaling via a downlink subband 240 while simultaneously receiving signaling via an uplink subband 245. In some cases, the downlink subband 240 may be separated from the uplink subband 245 in frequency by a guard band.

In the example of FIG. 1, the UEs 115 may operate according to half duplex (HD) while the network entity 105-a may operate according to SBFD. While operating according to SB FD, the network entity 105-a may simultaneously receive signaling from the UE 115-b via the uplink subband 245 and transmit signaling to the UE 115-a via the downlink subband 240. Because the UE 115-a receives the signaling from the network entity 105-a during the same time resources that the UE 115-b transmits the signaling to the network entity 105-a, the UE 115-a may experience UE-to-UE CLI. That is, the signaling transmitted from the UE 115-b may interfere with the reception of the signaling at the UE 115-a.

For CLI handling, the UE 115-a may determine CLI experienced by the UE 115-a and report the CLI to the network entity 105-a. The UE 115-a may utilize multiple methods to determine the CLI. For example, the UE 115-a may utilize one or both of RSRP measurements or RSSI measurements to determine the CLI. In order to obtain the CLI measurements, the UE 115-a may allocate resources of a BW configured to the UE 115-a for CLI measurements. In some examples, resources allocated for RSSI measurement may not be used by the UE 115-a for transmission or reception. Further, RSSI measurements may be performed in the uplink subband 245 or the downlink subband 240. RSRP measurements, on the other hand, may be performed in the uplink subband 245.

As described herein, the network entity 105-a may transmit a configuration signal 210 to the UE 115-a configuring the UE 115-a with one or more CLI resource mappings 230. In some examples, the BW configured to the UE 115-a for communication with the network entity 105-a may be divided in resource blocks (RBs) which may be further divided into REs. Each of the one or more CLI resource mappings 230 may indicate which REs of an RB are to be used for CLI measurements (e.g., RSRP measurement or RSSI measurements).

In some examples, the one or more CLI resource mappings 230 may include a resource mapping that is based on a resource mapping configured to the UE 115-a for channel state information interference measurement (CSI-IM). Alternatively or additionally, the one or more CLI resource mappings 230 may include a resource mapping that indicates to utilize all REs of a RB for CLI measurement. Alternatively or additionally, the one or more CLI resource mappings may include a resource mapping that is based on a comb-x pattern. The variable x may indicate which subcarriers of an RB are used for CLI measurement. For example, a comb-2 pattern may indicate that every second subcarrier of a symbol of an RB may be used for CLI measurement. In some examples, the comb-x pattern may include a comb-2 pattern, a comb-4 pattern, or a comb-8 pattern. Further, the one or more CLI resource mappings 230 may include a quantity of symbols to apply the comb-x pattern to, a timing offset associated with the comb-x pattern, or a frequency offset associated with the comb-x pattern. Alternatively or additionally, the one or more CLI resource mappings may include a resource mapping that is based on a resource mapping configured to the UE 115-a for ZP-CSI-RSS.

Alternatively or additionally, the one or more CLI resource mappings 230 may include a resource mapping that is based on a resource mapping configured to the UE 115-a for CSI measurements. Table 1 illustrates a candidate list of resource mappings configured for CSI measurements. In Table 1, the variables k and l may define the location of an REs within an RB. As one option, the CLI resource mappings 230 may include either row 1 or row 2 of Table 1. As another option, the CLI resource mappings 230 may include any of the rows of Table 1. In some examples, a single CDM group of a respective row is used for CLI measurement. If multiple CDM groups are listed, the CDM group to be used for CLI measurement may include the first listed CDM group or the CDM group to be used to for CLI measurement may be pre-configured via a parameter in RRC. Alternatively, if multiple CDM groups are listed, all CDM groups of a respective row are used for CLI measurement.

TABLE 1

| | | | | | CDM group | | |
|---|---|---|---|---|---|---|---|
| Row | Ports | Density | cdm-Type | (k̅, l̅) | index | k′ | l′ |
| 1 | 1 | 3 | noCDM | (k₀, l₀), (k₀ + 4, l₀), (k₀ + | 0, 0, 0 | 0 | 0 |
| | | | | 8, l₀) | | | |
| 2 | 1 | 1, 0.5 | noCDM | (k₀, l₀) | 0 | 0 | 0 |
| 3 | 2 | 1, 0.5 | fd-CDM2 | (k₀, l₀) | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), | 0, 1, 2, 3 | 0, 1 | 0 |
| | | | | (k₃, l₀) | | | |
| 7 | 8 | 1 | fd-CDM2 | (k₀, l₀), (k₁, l₀), (k₀, l₀ + 1), | 0, 1, 2, 3 | 0, 1 | 0 |
| | | | | (k₁, l₀ + 1) | | | |
| 8 | 8 | 1 | cdm4- | (k₀, l₀), (k₁, l₀) | 0, 1 | 0, 1 | 0, 1 |
| | | | FD2-TD2 | | | | |
| 9 | 12 | 1 | fd-CDM2 | (k₀, l₀), (k₁, l₀), (k₂, l₀), | 0, 1, 2, 3, 4, 5 | 0, 1 | 0 |
| | | | | (k₃, l₀), (k₄, l₀), (k₅, l₀) | | | |
| 10 | 12 | 1 | cdm4- | (k₀, l₀), (k₁, l₀), (k₂, l₀) | 0, 1, 2 | 0, 1 | 0, 1 |
| | | | FD2-TD2 | | | | |
| 11 | 16 | 1, 0.5 | fd-CDM2 | (k₀, l₀), (k₁, l₀), (k₂, l₀), | 0, 1, 2, 3, 4, | 0, 1 | 0 |
| | | | | (k₃, l₀), (k₀, l₀ + 1), (k₁, l₀ + | 5, 6, 7 | | |
| | | | | 1), (k₂, l₀ + 1), (k₃, l₀ + 1) | | | |
| 12 | 16 | 1, 0.5 | cdm4- | (k₀, l₀), (k₁, l₀), (k₂, l₀), | 0, 1, 2, 3 | 0, 1 | 0, 1 |
| | | | FD2-TD2 | (k₃, l₀) | | | |
| 13 | 24 | 1, 0.5 | fd-CDM2 | (k₀, l₀), (k₁, l₀), (k₂, l₀), | 0, 1, 2, 3, 4, 5, | 0, 1 | 0 |
| | | | | (k₀, l₀ + 1), (k₁, l₀ + 1), | 6, 7, 8, 9, 10, 11 | | |
| | | | | (k₂, l₀ + 1), (k₀, l₁), (k₁, l₁), | | | |
| | | | | (k₂, l₁), (k₀, l₁ + 1), (k₁, l₁ + | | | |
| | | | | 1), (k₂, l₁ + 1) | | | |
| 14 | 24 | 1, 0.5 | cdm4- | (k₀, l₀), (k₁, l₀), (k₂, l₀), | 0, 1, 2, 3, 4, 5 | 0, 1 | 0, 1 |
| | | | FD2-TD2 | (k₀, l₁), (k₁, l₁), (k₂, l₁) | | | |
| 15 | 24 | 1, 0.5 | cdm8- | (k₀, l₀), (k₁, l₀), (k₂, l₀) | 0, 1, 2 | 0, 1 | 0, 1, 2, 3 |
| | | | FD2-TD2 | | | | |
| 16 | 32 | 1, 0.5 | fd-CDM3 | (k₀, l₀), (k₁, l₀), (k₂, l₀), | 0, 1, 2, 3, 4, 5, | 0, 1 | 0 |
| | | | | (k₃, l₀), (k₀, l₀ + 1), (k₁, l₀ + | 6, 7, 8, 9, 10, 11 | | |
| | | | | 1), (k₂, l₀ + 1), (k₃, l₀ + 1), | 12, 13, 14, 15 | | |
| | | | | (k₀, l₁), (k₁, l₁), (k₂, l₁), | | | |
| | | | | (k₃, l₁), (k₀, l₁ + ₁), (k₁, l₁ + | | | |
| | | | | 1), (k₂, l₁ + 1), (k₃, l₁ + 1) | | | |
| 17 | 32 | 1, 0.5 | cdm4- | (k₀, l₀), (k₁, l₀), (k₂, l₀), | 0, 1, 2, 3, 4, 5, | 0, 1 | 0, 1 |
| | | | FD2-TD2 | (k₃, l₀), (k₀, l₁), (k₁, l₁), | 6, 7 | | |
| | | | | (k₂, l₁), (k₃, l₁) | | | |
| 18 | 32 | 1, 0.5 | Cdm8- | (k₀, l₀), (k₁, l₀), (k₂, l₀), | 0, 1, 2, 3 | 0, 1 | 0, 1, 2, 3 |
| | | | FD2-TD2 | (k₃, l₀) | | | |

In addition to the one or more CLI resource mappings 230, the configuration signal 210 may include a CLI RB mapping. The CLI RB mapping may indicate which RBs of the configured BW to apply the one or more CLI resource mappings 230 to. In one example, the RSSI RB mapping may indicate to apply the CLI resource mappings 230 to all RBs of the configured BW. In another example, the CLI RB mapping may correspond to a configured density. For example, if the CLI RB mapping is set to a value of 1, the CLI resource mapping 230 may be applied to every RB of the configured BW. Alternatively, if the CLI RB mapping is set to a value of 0.5, the CLI resource mapping may be applied to every other RB of the configured BW. As another example, the CLI RB mapping may be non-uniform. That is, the CLI RB mapping may indicate to apply the CLI resource mapping to any combination of RBs of the configured BW.

In some examples, resource(s) used to measure CLI may overlap with a downlink data channel (e.g., a PDSCH) of the downlink subband 240. To account for such scenarios, the configuration signal 210 may further include one or more CLI rate matching patterns 235 that the UE 115-a may utilize to simultaneously measure CLI and receive downlink data signaling using the downlink channel.

In one example, the configuration signal 210 may include a first information element (IE) that indicates one or more rate matching patterns for ZP-CSI-RS. The first IE may be enhanced to include at least one of the CLI resource mappings 230 or a different resource mapping which the UE 115-a may then use to determine the CLI rate matching pattern 235. For example, the first IE may be enhanced to include a comb-2 pattern. As another option, the configuration signal 210 may include a second IE that indicates the one or more CLI rate matching patterns 235. In some examples, the one or more CLI rate matching patterns 235 may include at least one of the CLI resource mappings 230. For example, the second IE may include a comb-2 pattern. The UE 115-a may utilize the second IE to determine the CLI rate matching pattern 235.

In some examples, prior to receiving the configuration signal 210, the UE 115-a may transmit a capability signal 205 to the network entity 105-a. The capability signal 205 may define which of the one or more CLI resource mappings 230 or which of the one or more CLI rate matching patterns 235 are supported by the UE 115-a. In some examples, the UE 115-a may support different CLI resource mappings 230 in the uplink subband 245 vs. the downlink subband 240. In such case, the capability signal 205 may indicate that the UE 115-a supports at least a first CLI resource mapping 230 for CLI measurement in the uplink subband 245 and a second CLI resource mapping 230 for CLI measurement in the downlink subband.

Additionally, or alternatively, the UE 115-a may support different CLI resource mappings 230 depending on a CLI metric to be measured (e.g., RSSI vs. RSRP) by the UE 115-a. In such case, the capability signaling may indicate that the UE 115-a supports at least a first CLI resource mapping 230 for RSRP measurement and a second CLI resource mapping 230 for RSSI measurement. For example, the capability signal 205 may indicate that the UE 115-a supports comb patterns for RSRP measurement, but does not support comb patterns for RSSI measurement.

In some examples, after receiving the configuration signal 210, the UE 115-a may communicate with the network entity 105-a. During communication, the UE 115-a may perform CLI measurement in the downlink data channel. In such scenario, the CLI manager 225 of the UE 115-a may simultaneously receive a data signal 215 from the network entity 105-a using a first set of resources of the downlink channel and measure CLI in a second set of resources of the downlink channel according to a CLI rate matching pattern 235 of the one or more CLI rate matching patterns. As such, the data signal may be rate matched around CLI measurement resources.

Upon measuring the CLI, the UE 115-a may generate a CLI report 220 that includes the CLI measurements. In some examples, the CLI report 220 may include RSSI measurements, RSRP measurements, or both. The UE 115-a may then transmit the CLI report 220 to the network entity 105-a.

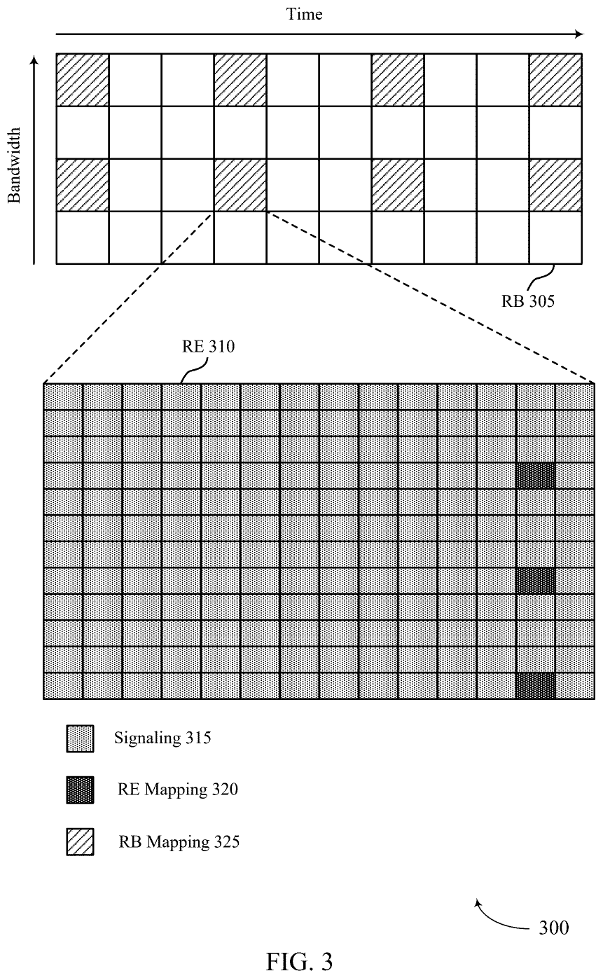

FIG. 3 shows an example of a resource pattern 300 that supports resource and rate matching patterns for CLI measurements in SB FD in accordance with one or more aspects of the present disclosure. In some examples, aspects of the resource pattern 300 may be implemented by aspects of the wireless communications system 100 and the wireless communications system 200. For example, the resource pattern 300 may be implemented by a UE 115 or a network entity 105 as described with reference to FIGS. 1 and 2.

In some examples, a UE may communicate with a network entity using a configured BW. As shown in FIG. 3, the configured BW may include multiple RBs 305 and each RB 305 may include a respective set of REs 310. In some examples, each RB 305 may span 14 symbols and 12 subcarriers.

As described with reference to FIG. 2, the UE may perform CLI measurement and as such, may be configured with an RE mapping 320 for CLI measurement. The RE mapping 320 may indicate which REs 310 of a respective RB 305 may be utilized for CLI measurement. Additionally, the UE may be configured with an RB mapping 325. The RB mapping 325 may indicate which RBs of the configured BW to which to apply the at least one RE mapping 320.

In the example of FIG. 3, the RB mapping 325 may indicate to apply the RE mapping 320 to every other RB 305 of the configured BW at a periodicity of three slots. However, other RB mappings are possible. For example, the RB mapping 325 may indicate to apply the RE mapping 320 to all of the RBs 305 of the configured BW. As another example, the RB mapping 325 may be dynamic. For example, the RB mapping 325 may include a parameter that indicates an RB density at which to apply the RE mapping 320. For example, if a value of the parameter is 1, the RE mapping 320 may be applied to every RB 305 of the configured BW. Alternatively, if the value of the parameter is ½, the RE mapping 320 may be applied to every other RB 305. Further, the RB mapping 320 may not apply to every slot. In such examples, the RB mapping 320 or other parameter may indicate a periodicity that indicates which slots to apply the RB mapping 320 to.

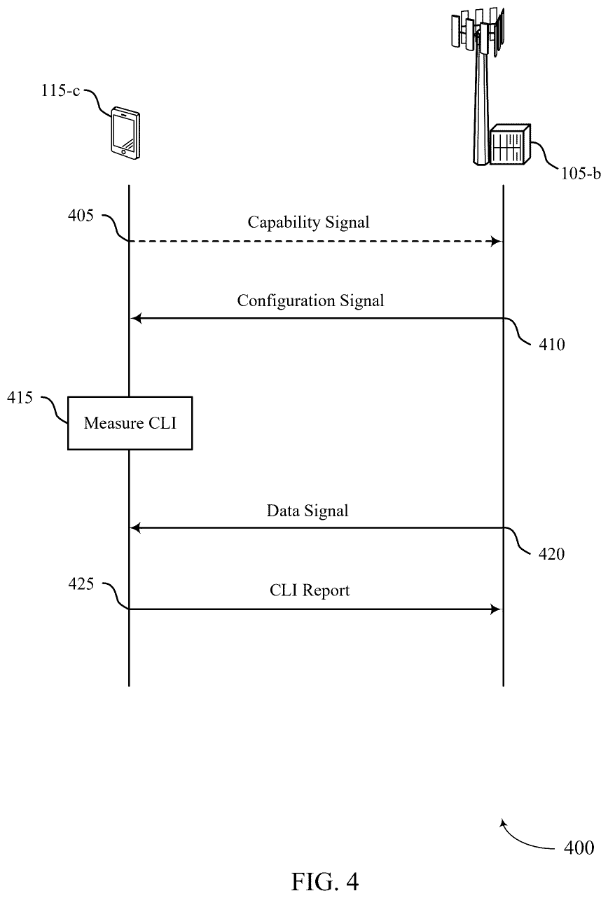

To each of the RBs 305 indicated by the RB mapping 325, the UE 115 may apply the RE mapping 320. As illustrated in FIG. 3, the RE mapping 320 may indicate to perform CLI measurement in REs 310 according to a comb-4 pattern. Although FIG. 4 illustrates a comb-4 pattern, other RE mappings 320 are possible. For example, the RE mapping 320 may include a mapping similar to or the same as one of the mappings configured for CSI-IM, a mapping similar to or the same as one of the mappings configured for CSI measurement, or a mapping similar to or the same as one or more mappings configured for ZP-CSI-RSs. As another example, the RE mapping 320 may include a comb-2 pattern or a comb-4 pattern. In yet another example, the RE mapping 320 may indicate to perform CLI measurement in all REs 310 of the respective RB 305. The remaining REs 310 of the RB 305 may be allocated for different signaling 315 (e.g., uplink signaling or downlink signaling).

In some examples, RBs 305 reserved for CLI measurement may overlap with a downlink data channel (e.g., a PDSCH) of the UE. In such examples, the UE 115 may be additionally configured with a rate matching pattern for simultaneously receiving data signaling and performing CLI measurements in the downlink data channel. In some examples, the rate matching pattern may include or indicate one of the RE mappings 320 (e.g., a comb-2 pattern). In some examples, an IE may be defined for CLI measurement and may indicate the rate matching pattern. In another example, an IE defined for ZP-CSI-RS may be enhanced to include the rate matching pattern.

Upon identifying the RB mapping 325, the RE mapping 320, and the rate matching pattern, the UE may communicate with the network entity. In RBs 305 allocated for CLI measurement, the UE may measure CLI in REs 310 according to the RE mapping 320 or the rate matching patten (e.g., if the RBs 305 overlaps with the PDSCH). In some examples, measuring CLI may include measuring RSSI or RSRP. Upon measuring the CLI, the UE may generate a CLI report that indicates the CLI and transmit the CLI report to the network entity.

FIG. 4 shows an example of a process flow 400 that supports resource and rate matching patterns for CLI measurements in SBFD in accordance with one or more aspects of the present disclosure. In some examples, the process flow 400 may implement, or be implemented by, aspects of the wireless communications system 100, the wireless communications system 200, or the resource pattern 300. For example, the process flow 400 may be implemented by a UE 115-c which may be an example of a UE 115 as described with reference to FIGS. 1 and 2. Further, the process flow 400 may be implemented by the network entity 105-b which may be an example of a network entity 105 as described with reference to FIGS. 1 and 2. Alternative examples of the following may be implemented, where some steps are performed in a different order than described or are not performed at all. In some cases, steps may include additional features not mentioned below, or further steps may be added.

At 405, the UE 115-c may optionally transmit, to the network entity 105-b, a signal (e.g., a capability signal) indicating a capability of the UE 115-c to support one or more resource mappings for CLI measurements, one or more rate matching patterns associated with receiving a data signal multiplexed with the CLI measurements, or both.

At 410, the UE 115-c may receive, from the network entity 105-b, a signal (e.g., a configuration signal) configuring the UE 115-c with the one or more resource mappings and the one or more rate matching patterns. In some examples, a resource mapping of the one or more resource mappings may indicate to utilize all REs of a RB to perform CLI measurements. Additionally, or alternatively, the one or more resource mappings may include a comb pattern.

Additionally, or alternatively, the UE 115-c may receive, from the network entity 105-b, a signal configuring the UE 115-c with one or more second resource mappings associated with CSI measurements and the one or more resource mappings may include a resource mapping of the one or more second resource mappings.

Additionally, or alternatively, the UE 115-c may receive, from the network entity 105-b, a signal configuring the UE 115-c with one or more third resource mappings associated with CSI-IM and the one or more resource mappings may include a resource mapping of the one or more third resource mappings.

In some examples, the configuration signal may additionally include a RB mapping. The RB mapping may indicate to perform CLI measurements in every RB of a BW associated with the UE 115-c. Alternatively, the RB mapping may indicate to perform CLI measurement in a subset of RBs of the BW associated with the UE 115-c.

In some examples, the configuration signal may include an IE associated with CLI measurements that indicates the one or more rate matching patterns. Additionally, or alternatively, the configuration signal may include an IE associated with ZP-CSI-RSs that indicates the one or more rate matching patterns.

At 415, the UE 115-c may measure CLI in a first set of resources (e.g., one or more first resources) of a downlink data channel in accordance with a rate matching pattern of the one or more rate matching patterns.

At 420, the UE 115-c may receive. from the network entity 105-b, the data

signal via a second set of resources (e.g., one or more second resources) of the downlink channel in accordance with the rate matching pattern.

At 425, the UE 115-c may transmit, to the network entity 105-b, a CLI report that indicates the measured CLI. In some examples, the CLI report may include RSSI measurements.

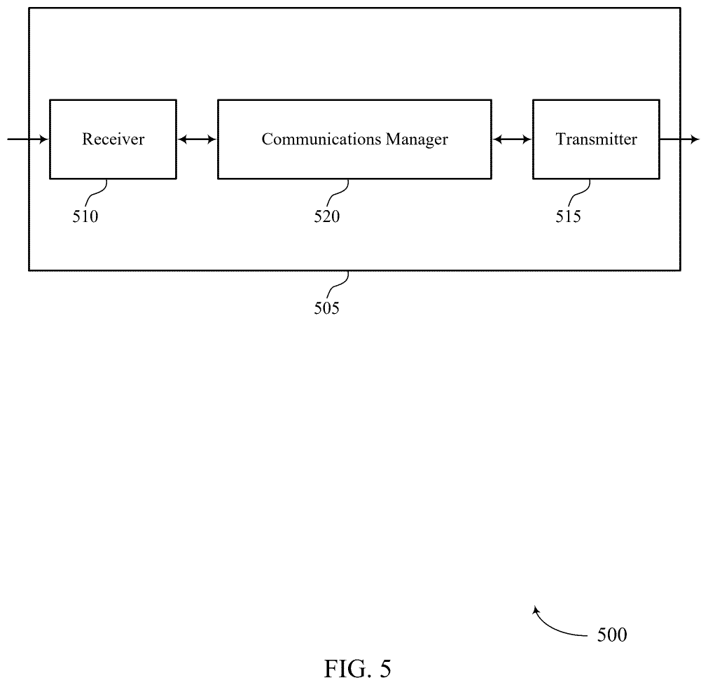

FIG. 5 shows a block diagram 500 of a device 505 that supports resource and rate matching patterns for CLI measurements in SB FD in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to resource and rate matching patterns for CLI measurements in SBFD). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to resource and rate matching patterns for CLI measurements in SBFD). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of resource and rate matching patterns for CLI measurements in SBFD as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a signal configuring the UE with one or more resource mappings associated with CLI measurements and one or more rate matching patterns associated with receiving a data signal multiplexed with the CLI measurements. The communications manager 520 is capable of, configured to, or operable to support a means for measuring CLI in a first set of resources of a downlink data channel in accordance with a rate matching pattern of the one or more rate matching patterns. The communications manager 520 is capable of, configured to, or operable to support a means for receiving the data signal via a second set of resources of the downlink data channel in accordance with the rate matching pattern. The communications manager 520 is capable of, configured to, or operable to support a means for transmitting a report indicating the measured CLI.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

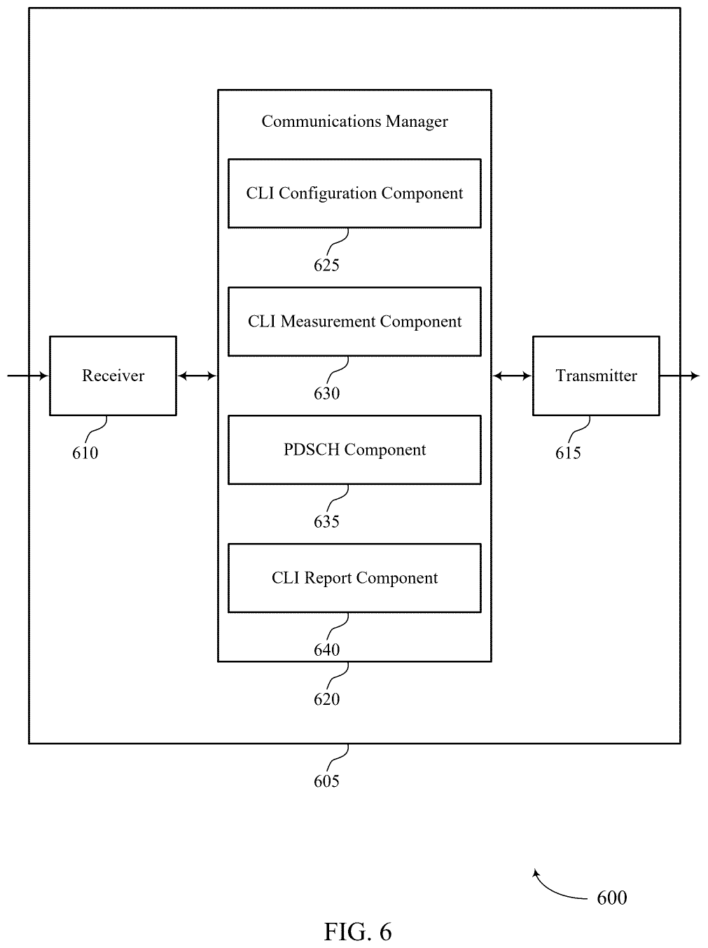

FIG. 6 shows a block diagram 600 of a device 605 that supports resource and rate matching patterns for CLI measurements in SBFD in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to resource and rate matching patterns for CLI measurements in SBFD). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to resource and rate matching patterns for CLI measurements in SBFD). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of resource and rate matching patterns for CLI measurements in SBFD as described herein. For example, the communications manager 620 may include a CLI configuration component 625, a CLI measurement component 630, an PDSCH component 635, a CLI report component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The CLI configuration component 625 is capable of, configured to, or operable to support a means for receiving a signal configuring the UE with one or more resource mappings associated with CLI measurements and one or more rate matching patterns associated with receiving a data signal multiplexed with the CLI measurements. The CLI measurement component 630 is capable of, configured to, or operable to support a means for measuring CLI in a first set of resources of a downlink data channel in accordance with a rate matching pattern of the one or more rate matching patterns. The PDSCH component 635 is capable of, configured to, or operable to support a means for receiving the data signal via a second set of resources of the downlink data channel in accordance with the rate matching pattern. The CLI report component 640 is capable of, configured to, or operable to support a means for transmitting a report indicating the measured CLI.

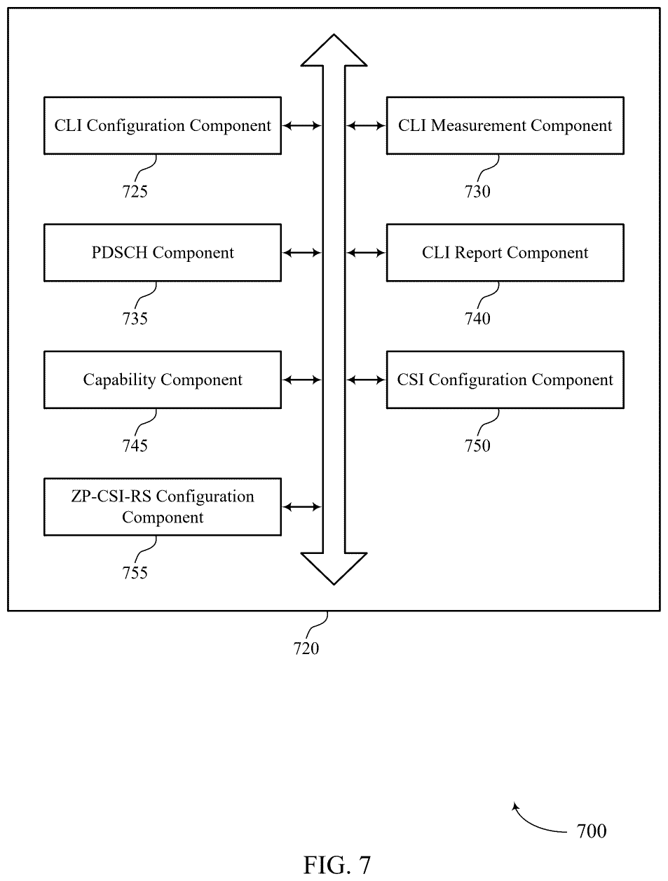

FIG. 7 shows a block diagram 700 of a communications manager 720 that supports resource and rate matching patterns for CLI measurements in SBFD in accordance with one or more aspects of the present disclosure. The communications manager 720 may be an example of aspects of a communications manager 520, a communications manager 620, or both, as described herein. The communications manager 720, or various components thereof, may be an example of means for performing various aspects of resource and rate matching patterns for CLI measurements in SB FD as described herein. For example, the communications manager 720 may include a CLI configuration component 725, a CLI measurement component 730, an PDSCH component 735, a CLI report component 740, a capability component 745, a CSI configuration component 750, a ZP-CSI-RS configuration component 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The CLI configuration component 725 is capable of, configured to, or operable to support a means for receiving a signal configuring the UE with one or more resource mappings associated with CLI measurements and one or more rate matching patterns associated with receiving a data signal multiplexed with the CLI measurements. The CLI measurement component 730 is capable of, configured to, or operable to support a means for measuring CLI in a first set of resources of a downlink data channel in accordance with a rate matching pattern of the one or more rate matching patterns. The PDSCH component 735 is capable of, configured to, or operable to support a means for receiving the data signal via a second set of resources of the downlink data channel in accordance with the rate matching pattern. The CLI report component 740 is capable of, configured to, or operable to support a means for transmitting a report indicating the measured CLI.

In some examples, the capability component 745 is capable of, configured to, or operable to support a means for transmitting a signal indicating a capability of the UE to support the one or more resource mappings, the one or more rate matching patterns, or both, where receiving the signal configuring the UE with the one or more resource mappings and the one or more rate matching patterns is based on the signal indicating the capability to support the one or more resource mappings, the one or more rate matching patterns, or both.

In some examples, the CSI configuration component 750 is capable of, configured to, or operable to support a means for receiving a signal configuring the UE with one or more second resource mappings associated with CSI measurements, where the one or more resource mappings include a resource mapping of the one or more second resource mappings.

In some examples, the ZP-CSI-RS configuration component 755 is capable of, configured to, or operable to support a means for receiving a signal configuring the UE with one or more third resource mappings associated with CSI-IM, where the one or more resource mappings include a resource mapping of the one or more third resource mappings.

In some examples, a resource mapping of the one or more resource mappings indicates to utilize all REs of a RB to perform CLI measurements. In some examples, the one or more resource mappings include a comb pattern.

In some examples, the signal configuring the UE with the one or more resource mappings and the one or more rate matching patterns indicates to perform CLI measurements in every RB of a BW associated with the UE.

In some examples, the signal configuring the UE with the one or more resource mappings and the one or more rate matching patterns indicates to perform CLI measurements in a subset of RBs of a BW associated with the UE.

In some examples, the signal configuring the UE with the one or more resource mappings and the one or more rate matching patterns includes an IE associated with CLI measurements. In some examples, the IE includes the one or more rate matching patterns.

In some examples, the signal configuring the UE with the one or more resource mappings and the one or more rate matching patterns includes an IE associated with ZP-CSI-RSs. In some examples, the IE includes the one or more rate matching patterns. In some examples, the report includes RSSI measurements.

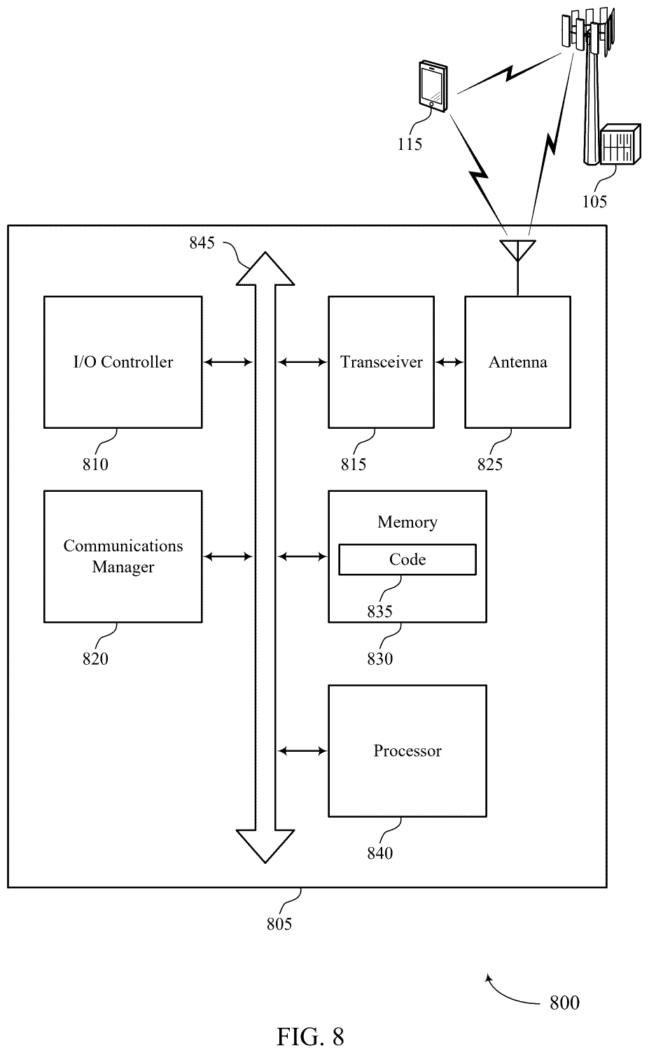

FIG. 8 shows a diagram of a system 800 including a device 805 that supports resource and rate matching patterns for CLI measurements in SBFD in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPU s), one or more neural processing units (NPUs) (also referred to as neural network processors or deep learning processors (DLPs)), one or more microcontrollers, one or more A SICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting resource and rate matching patterns for CLI measurements in SBFD). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a signal configuring the UE with one or more resource mappings associated with CLI measurements and one or more rate matching patterns associated with receiving a data signal multiplexed with the CLI measurements. The communications manager 820 is capable of, configured to, or operable to support a means for measuring CLI in a first set of resources of a downlink data channel in accordance with a rate matching pattern of the one or more rate matching patterns. The communications manager 820 is capable of, configured to, or operable to support a means for receiving the data signal via a second set of resources of the downlink data channel in accordance with the rate matching pattern. The communications manager 820 is capable of, configured to, or operable to support a means for transmitting a report indicating the measured CLI.

By including or configuring the communications manager 820 in accordance with examples as described herein, the device 805 may support techniques for improved communication reliability, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of resource and rate matching patterns for CLI measurements in SBFD as described herein, or the at least one processor 840 and the at least one memory 830 may be otherwise configured to, individually or collectively, perform or support such operations.

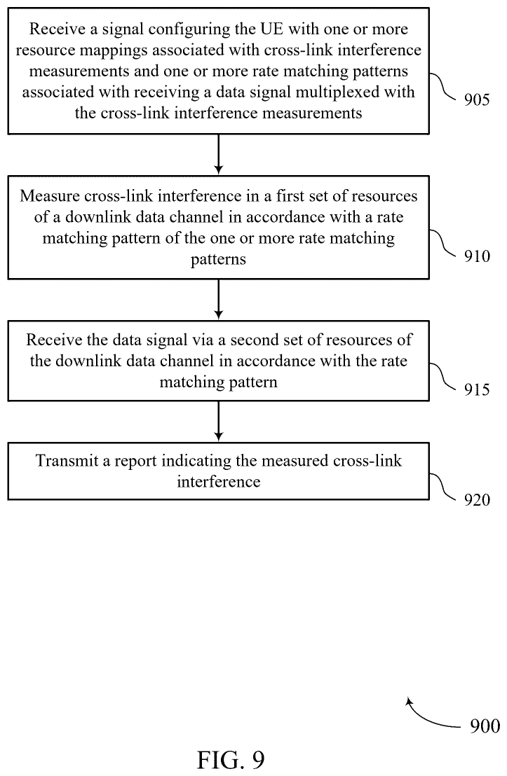

FIG. 9 shows a flowchart illustrating a method 900 that supports resource and rate matching patterns for CLI measurements in SBFD in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a signal configuring the UE with one or more resource mappings associated with CLI measurements and one or more rate matching patterns associated with receiving a data signal multiplexed with the CLI measurements. The operations of 905 may be performed in accordance with examples as disclosed herein. In some examples, aspects of the operations of 905 may be performed by a CLI configuration component 725 as described with reference to FIG. 7.

At 910, the method may include measuring CLI in a first set of resources of a downlink data channel in accordance with a rate matching pattern of the one or more rate matching patterns. The operations of 910 may be performed in accordance with examples as disclosed herein. In some examples, aspects of the operations of 910 may be performed by a CLI measurement component 730 as described with reference to FIG. 7.

At 915, the method may include receiving the data signal via a second set of resources of the downlink data channel in accordance with the rate matching pattern. The operations of 915 may be performed in accordance with examples as disclosed herein. In some examples, aspects of the operations of 915 may be performed by an PDSCH component 735 as described with reference to FIG. 7.

At 920, the method may include transmitting a report indicating the measured CLI. The operations of 920 may be performed in accordance with examples as disclosed herein. In some examples, aspects of the operations of 920 may be performed by a CLI report component 740 as described with reference to FIG. 7.

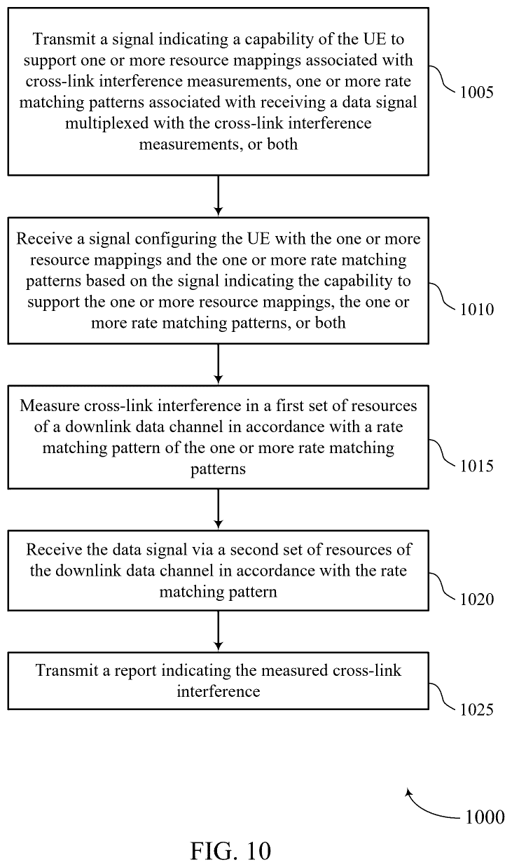

FIG. 10 shows a flowchart illustrating a method 1000 that supports resource and rate matching patterns for CLI measurements in SB FD in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting a signal indicating a capability of the UE to support one or more resource mappings associated with CLI measurements, one or more rate matching patterns associated with receiving a data signal multiplexed with the CLI measurements, or both. The operations of 1005 may be performed in accordance with examples as disclosed herein. In some examples, aspects of the operations of 1005 may be performed by a capability component 745 as described with reference to FIG. 7.

At 1010, the method may include receiving a signal configuring the UE with the one or more resource mappings and the one or more rate matching patterns based on the signal indicating the capability to support the one or more resource mappings, the one or more rate matching patterns, or both. The operations of 1010 may be performed in accordance with examples as disclosed herein. In some examples, aspects of the operations of 1010 may be performed by a CLI configuration component 725 as described with reference to FIG. 7.

At 1015, the method may include measuring CLI in a first set of resources of a downlink data channel in accordance with a rate matching pattern of the one or more rate matching patterns. The operations of 1015 may be performed in accordance with examples as disclosed herein. In some examples, aspects of the operations of 1015 may be performed by a CLI measurement component 730 as described with reference to FIG. 7.

At 1020, the method may include receiving the data signal via a second set of resources of the downlink data channel in accordance with the rate matching pattern. The operations of 1020 may be performed in accordance with examples as disclosed herein. In some examples, aspects of the operations of 1020 may be performed by an PDSCH component 735 as described with reference to FIG. 7.

At 1025, the method may include transmitting a report indicating the measured CLI. The operations of 1025 may be performed in accordance with examples as disclosed herein. In some examples, aspects of the operations of 1025 may be performed by a CLI report component 740 as described with reference to FIG. 7.

The following provides an overview of aspects of the present disclosure:
Aspect 1: A method for wireless communications at a UE, comprising: receiving a signal configuring the UE with one or more resource mappings associated with CLI measurements and one or more rate matching patterns associated with receiving a data signal multiplexed with the CLI measurements; measuring CLI in a first set of resources of a downlink data channel in accordance with a rate matching pattern of the one or more rate matching patterns; receiving the data signal via a second set of resources of the downlink data channel in accordance with the rate matching pattern; and transmitting a report indicating the measured CLI.
Aspect 2: The method of aspect 1, further comprising: transmitting a signal indicating a capability of the UE to support the one or more resource mappings, the one or more rate matching patterns, or both, wherein receiving the signal configuring the UE with the one or more resource mappings and the one or more rate matching patterns is based on the signal indicating the capability to support the one or more resource mappings, the one or more rate matching patterns, or both.
Aspect 3: The method of any of aspects 1 through 2, further comprising: receiving a signal configuring the UE with one or more second resource mappings associated with CSI measurements, wherein the one or more resource mappings comprise a resource mapping of the one or more second resource mappings.
Aspect 4: The method of any of aspects 1 through 3, further comprising: receiving a signal configuring the UE with one or more third resource mappings associated with CSI-IM, wherein the one or more resource mappings comprise a resource mapping of the one or more third resource mappings.
Aspect 5: The method of any of aspects 1 through 4, wherein a resource mapping of the one or more resource mappings indicates to utilize all REs of an RB to perform CLI measurements.
Aspect 6: The method of any of aspects 1 through 5, wherein the one or more resource mappings comprise a comb pattern.
Aspect 7: The method of any of aspects 1 through 6, wherein the signal configuring the UE with the one or more resource mappings and the one or more rate matching patterns indicates to perform CLI measurements in every RB of a BW associated with the UE.
Aspect 8: The method of any of aspects 1 through 7, wherein the signal configuring the UE with the one or more resource mappings and the one or more rate matching patterns indicates to perform CLI measurements in a subset of RBs of a BW associated with the UE.
Aspect 9: The method of any of aspects 1 through 8, wherein the signal configuring the UE with the one or more resource mappings and the one or more rate matching patterns comprises an IE associated with CLI measurements, the IE comprises the one or more resource mappings, and the one or more rate matching patterns are based at least in part on the one or more resource mappings.
Aspect 10: The method of any of aspects 1 through 9, wherein the signal configuring the UE with the one or more resource mappings and the one or more rate matching patterns comprises an IE associated with ZP-CSI-RSs, the IE comprises the one or more rate matching patterns.
Aspect 11: The method of any of aspects 1 through 10, wherein the report comprises RSSI measurements.
Aspect 12: A UE for wireless communications, comprising one or more memories storing processor-executable code, and one or more processors coupled with the one or more memories and individually or collectively operable to execute the code to cause the UE to perform a method of any of aspects 1 through 11.
Aspect 13: A UE for wireless communications, comprising at least one means for performing a method of any of aspects 1 through 11.
Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. A Iso, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more processors; and
instructions stored in one or more memories and executable by the one or more processors, individually or collectively, to cause the apparatus to:
receive a signal configuring the UE with one or more resource mappings associated with cross link interference measurements and one or more rate matching patterns associated with receiving a data signal multiplexed with the cross link interference measurements;
measure cross link interference in a first set of resources of a downlink data channel in accordance with a rate matching pattern of the one or more rate matching patterns;
receive the data signal via a second set of resources of the downlink data channel in accordance with the rate matching pattern; and
transmit a report indicating the measured cross link interference.

2. The apparatus of claim 1, wherein the one or more processors are individually or collectively further operable to execute the instructions to cause the apparatus to:
transmit a signal indicating a capability of the UE to support the one or more resource mappings, the one or more rate matching patterns, or both, wherein receiving the signal configuring the UE with the one or more resource mappings and the one or more rate matching patterns is based on the signal indicating the capability to support the one or more resource mappings, the one or more rate matching patterns, or both.

3. The apparatus of claim 1, wherein the one or more processors are individually or collectively further operable to execute the instructions to cause the apparatus to:
receive a signal configuring the UE with one or more second resource mappings associated with channel state information measurements, wherein the one or more resource mappings comprise a resource mapping of the one or more second resource mappings.

4. The apparatus of claim 1, wherein the one or more processors are individually or collectively further operable to execute the instructions to cause the apparatus to:
receive a signal configuring the UE with one or more third resource mappings associated with channel state information interference measurements, wherein the one or more resource mappings comprise a resource mapping of the one or more third resource mappings.

5. The apparatus of claim 1, wherein a resource mapping of the one or more resource mappings indicates to utilize all resource elements of a resource block to perform cross link interference measurements.

6. The apparatus of claim 1, wherein the one or more resource mappings comprise a comb pattern.

7. The apparatus of claim 1, wherein the signal configuring the UE with the one or more resource mappings and the one or more rate matching patterns indicates to perform cross link interference measurements in every resource block of a bandwidth associated with the UE.

8. The apparatus of claim 1, wherein the signal configuring the UE with the one or more resource mappings and the one or more rate matching patterns indicates to perform cross link interference measurements in a subset of resource blocks of a bandwidth associated with the UE.

9. The apparatus of claim 1, wherein the signal configuring the UE with the one or more resource mappings and the one or more rate matching patterns comprises an information element associated with cross link interference measurements, the information element comprising the one or more resource mappings, and wherein the one or more rate matching patterns are based at least in part on the one or more resource mappings.

10. The apparatus of claim 1, wherein the signal configuring the UE with the one or more resource mappings and the one or more rate matching patterns comprises an information element associated with zero power channel state information reference signals, the information element comprising the one or more rate matching patterns.

11. The apparatus of claim 1, wherein the report comprises received signal strength indicator measurements.

12. A method for wireless communications at a user equipment (UE), comprising:
receiving a signal configuring the UE with one or more resource mappings associated with cross link interference measurements and one or more rate matching patterns associated with receiving a data signal multiplexed with the cross link interference measurements;
measuring cross link interference in a first set of resources of a downlink data channel in accordance with a rate matching pattern of the one or more rate matching patterns;
receiving the data signal via a second set of resources of the downlink data channel in accordance with the rate matching pattern; and
transmitting a report indicating the measured cross link interference.

13. The method of claim 12, further comprising:
transmitting a signal indicating a capability of the UE to support the one or more resource mappings, the one or more rate matching patterns, or both, wherein receiving the signal configuring the UE with the one or more resource mappings and the one or more rate matching patterns is based on the signal indicating the capability to support the one or more resource mappings, the one or more rate matching patterns, or both.

14. The method of claim 12, further comprising:
receiving a signal configuring the UE with one or more second resource mappings associated with channel state information measurements, wherein the one or more resource mappings comprise a resource mapping of the one or more second resource mappings.

15. The method of claim 12, further comprising:
receiving a signal configuring the UE with one or more third resource mappings associated with channel state information interference measurements, wherein the one or more resource mappings comprise a resource mapping of the one or more third resource mappings.

16. The method of claim 12, wherein a resource mapping of the one or more resource mappings indicates to utilize all resource elements of a resource block to perform cross link interference measurements.

17. The method of claim 12, wherein the one or more resource mappings comprise a comb pattern.

18. The method of claim 12, wherein the signal configuring the UE with the one or more resource mappings and the one or more rate matching patterns indicates to perform cross link interference measurements in every resource block of a bandwidth associated with the UE.

19. The method of claim 12, wherein the signal configuring the UE with the one or more resource mappings and the one or more rate matching patterns indicates to perform cross link interference measurements in a subset of resource blocks of a bandwidth associated with the UE.

20. The method of claim 12, wherein the signal configuring the UE with the one or more resource mappings and the one or more rate matching patterns comprises an information element associated with cross link interference measurements, the information element comprising the one or more rate matching patterns.
